(19) United States
(12) Patent Application Publication
(10) Pub. No.: US 2005/0160442 A1
(43) Pub. Date: Jul. 21, 2005

(54) Optical data storage device protector

(76) Inventor: Gary H. Kaplowitz, University Place, WA (US)

Correspondence Address: Gary H. Kaplowitz, 4216 ROBIN RD. W., UNIVERSITY PLACE, WA, 98466, US

(21) Appl. No.: 10/758,999

(22) Filed: Jan. 16, 2004

(51) Int. Cl. G11B 7/24; G11B 23/03

(52) U.S. Cl. 720/719

(57) ABSTRACT

An optical data storage device protector comprised of two concentric rings. An outer ring is located near the outer periphery of the storage device and the inner ring's hole corresponds closely with the storage device's spindle hole. Both rings may be produced in a label sandwiched form having a peel away release liner, an adhesive that is preferably removable, a release coating facilitating removal of the release liner from the adhesive, a preferably high density face material that is adequately porous to receive a decorative finish and a face coating that serves to protect the decorative finish as well as to make the protector water resistant, UV light resistant and durable enough to withstand cleaning using either soap and water or wiper solutions available for device cleaning and reconditioning. The high density face material extends slightly beyond the device's edge affording edge cushioning and protection and also affords an inertial benefit, making the device more dynamically stable and thus skip resistant when used in portable storage device players.

### FIELD OF INVENTION

This invention relates to the protection of optical data storage devices of either audio in the form of compact discs (CD's) or audio and video devices in the form of digital video discs (DVD's). The present invention addresses specifically those semi-permanent disc protection devices intended to be applied to the disc and to remain in place with the disc in use rather than just for protection during disc storage.

### BACKGROUND OF THE INVENTION

In the art of compact disc and digital video disc protectors, a very limited number of “semi-permanent” protection devices intended to be used while the disc is in use have been invented. For the purposes of concise discussion, the term “disc” will be substituted for the term “optical data storage device”. For a cursory overview of the broader art, a brief discussion is herein made to provide a context for the more specific subclass into which the present invention falls. Within the broader art, the vast majority of disc protection devices are in the form of disc storage sleeves or cases. The universal objective of these devices, whether disc applied for protection while in use or as a storage device, is to prevent soiling and scratching of the disc's data surface that causes the music to skip or the video game or movie not to play. Some protectors of the prior art are intended to protect solely the label side, which contains the directory that is only covered by a relatively thin layer of lacquer. The most common and universally used product for device storage is the plastic “jewel” case that also comes in colored “jewel tones” for collection classification. (NEATO MEDIA Labeling Products, East Haven Conn.) is one such example. Other after market disc storage devices are also currently available in the form of paper and/or paper and Tyvek® sleeves. These products are currently available from (NEATO Media Labeling Products, East Haven Conn.) among others. Additionally, plastic sleeves for individual or multi-disc binder storage or clamshell type plastic protectors are also available from (Sleeve City, Memphis, Term.) or (NEATO Media Labeling Products, East Haven Conn.). Although these disc storage devices protect the discs from dirt and other damaging environmental factors, their protection is limited to their storage. The discs, once removed for use, are no longer protected and are thus susceptible to damage. Within the more narrow art of semi-permanent disc protection even fewer products are known and fall within two types. The first type is in the form of a solid barrier that is applied to the disk and the other is a solution and wiper system that “reconditions” the disc's surface. The need for a cost effective, easily applied semi-permanent protective device will be evident upon a thorough examination of the closest prior art, which is to follow. Among the earliest semi-permanent disc protection devices is the Phonograph Record Insulator, Aggarwal, U.S. Pat. No. 3,961,656. This invention was a pair of record insulators intended to provide protection of a phonograph record while in use and storage, particularly when played in stacking commercial “juke box” type players, where dust and contaminants trapped between multiple records made them quite susceptible to damage. Numerous rubber or foam spacers 21 were used to provide a cushioning benefit that prevented the play side cover from contacting the record's grooved data surface and thus protecting it from damage. The opposite insulator half contained a layer of electrically conductive material intended to remove static from the record's opposite side. However, unlike the present invention, Aggarwal's playing side cover, covered the entire data surface and was intended to be removed prior to the record being played. The advent of the digital data recording and playing disc brought a relatively durable means of protecting data in a permanent manner. One prime example of this form of product, as well as its prior history of the preceding prior art, is well described in Drexler, U.S. Pat. No. 4,319,252. Drexler describes a substrate 15 that receives the application by various possible means of a reflective data-carrying layer 17. This layer 17 received another very thin, contiguous, transparent but deliberately uneven coating 19 intended to provide a reflective buffer between the underlying data layer 17 and the final coverplate layer 21, thus preventing a readability problem caused by a phenomenon called Newton rings. Although Drexler's coverplate 21 is “preferably a durable material, such as glass or high impact plastic”, the need for additional protection of this surface became evident as scratching, smudging by contaminants and scuffing of this coverplate layer was found to cause read errors. This is a problem that still occurs in the present state of the art and prevention of this is an object of the present invention. Another permanent data protection device is presented in Marchant et al., U.S. Pat. No. 4,539,573. Marchant's invention is an optical disk unit having a flexible cover sheet 12 that is optically invisible to a laser reader, covering a data recording element 11 that is similar to Drexler's substrate and the aforementioned sandwiched assembly. Marchant's flexible cover sheet 12 is held under slight tension by spacers 13a, 13b, 13c & 14 that also create an air filled inter-space through which purified air is induced centrifugally through inlets 21 and relieved through outer vents 22. While Marchant's invention affords record element protection, it is a complex assembly whose cover sheet must be optically compatible in its refractive index and thereby relatively costly to produce for labor and materials. Further the inlet and outer vents are equally susceptible to being ports though which liquid contaminants can pass and damage the record element. As mentioned above, some offerings in the prior art for disc protection provide the additional object and advantage of providing minor scratch repair, which is not an object of the present invention. One type is a topically applied, static removal and sealant system, such as “Vivid CD & DVD Enhancer” (Walker Audio, Audubon, Pa.) This system utilizes a sequence of solutions and wipers designed to “recondition” the device data surface by cleaning the data surface, filling in minor scratches and making the storage device statically resistant so as to repel rather than attract dust. Another similar topically applied product, “Quick Shield” (CD/DVD Playright, Ludwigsburg, Germany) affords the additional benefits of sealing the disc from Ultra violet light, is an anti fungicide and creates a slippery surface that is resistant dust, grime and abrasion. While both topical products recondition, they do not provide a substantial solid barrier to guard or otherwise prevent the disc from contacting these damaging environmental factors, as does the present invention. Another product type that does afford a physical disc-protecting barrier is the CDfender as manufactured by Optidisc, Inc., London, UK (Burroughs, U.S. Pat. No. 6,240,061). This invention is a three-ply (polyester/polycarbonate/polyester) sandwiched product designed to protect both planar disc surfaces as well as the disc's edges. The outer layers of polyester serve to protect the polycarbonate layers that are the actual product applied to both the data-containing portions of the data surface and the label side. One “peel away” ply of polyester is to protect the outer surface of the polycarbonate layer. The opposite polyester layer protects a malleable “couplant” type of bonding agent that is designed to non-permanently adhere the polycarbonate layer to the disc and to create a contiguous bond, preventing air bubbles from obscuring the data. Another object of this couplant layer is to fill and thus repair fine scratches on the disc's read surface. Edge protection in Burroughs is accomplished by each planar layer containing a lip that extends perpendicularly to the disc applied surface offering the additional benefit of inertial mass to enhance stable operation. While this product appears to be effective in preventing disc data surface damage, there are several disadvantages to Burroughs invention. The costs of materials and manufacturing of this product is high due to the class 10000 clean room environment necessary to prevent contamination of the data side applied product and couplant prior to packaging and usage. Additionally, the expensive polycarbonate film 30, applied to the data surface, must be the same optical quality with a very close refractive index to that of the disc to assure successful use with a playback apparatus. Since Burroughs invention must be of close refractive index, being intended to cover the disc's data surface, it also precludes the ability to provide colored or even translucent color variation for decorative, marketing, advertising or collection categorization advantage, which is an object of the present invention. Although, Burroughs product is produced in a clean room environment, the environment where application by the consumer performed is very unlikely to be. Therefore, the probability of trapping dirt or other contaminants between the disc and the applied product is likely. If contamination occurs of this sort, causing disc read errors, contamination removal is not feasible without first removing the applied product and then its adhesive. Further, while Burroughs indicates this adhesive to be “preferably peelable to allow removal of the film should this prove necessary”, such removal is both time consuming and presents a repeated risk of damaging the data surface. The present invention does not cover the data-containing portion of the data surface but is applied in two parts adjacent to it on the read surface side of the disc. This advantage allows for data surface cleaning, as is done conventionally using mild soap & water or specifically formulated cleaning systems currently available on the market, without requiring the present inventions disc protector's removal. The materials described below for the present invention are also relatively durable, selected to allow cleaning without becoming damaged. In Burroughs, the processing requirements for the application of both adhesives are also complex and expensive. Burroughs's adhesive used with the disc's read surface was engineered to remove completely with the polyester so as not to leave an obscuring residue. Further, the couplant that bonds the polycarbonate layer to the disc must adhere completely to the polycarbonate device layer and not to the polyester layer to create a uniform refractive index in conjunction with the data surface applied layer. To accomplish this, an additionally expensive process called “corona treatment” is needed, using two universal roll corona treatment stations, as manufactured by Enercon Industries. Further, Burrough's CDfender is made of polycarbonate a durable yet hard plastic whose edge can readily scuff the surface of another disc's data surface or ironically the surface of Burrough's product applied to another disc. A subsequent invention of the specific genre of solid barrier digital disc protectors is Winicki, U.S. Pat. No. 6,385,164 who discloses a pair of optically invisible covers that enclose the disc, similar to those in Burroughs' invention. Winicki's disc cover is retained by either an acutely angled lip that overlaps the edge, or the covers can receive a ionized charge to statically bond the cover to the disc. Winicki bonding method solved Burroughs' problem with ease of removal for cleaning for the covers are indeed easier to remove than Burroughs' invention. Also since there is no peelable couplant layer to be removed prior to cleaning or replacement, the risk of damaging the data surface is minimized. However, like Burroughs, Winicki's invention covers the entire data-containing surface of the disk and, thereby, requires the same expensive optically compatible, polycarbonate presenting the same scuffing and dirt entrapment potential. Winicki's optically invisible covers must, in like manner to Burroughs, be by design perfectly transparent and cannot receive printing, decorative finishes, or be colored in any way. Unlike Burroughs CDfender or Winicki's protective cover, the present invention provides disc protection utility that is also cost effective to produce for both material cost and manufacturing method. The present invention is made of a paper based product material, much softer than the standard polycarbonate storage “disc” device and will not scuff nor leave a residue upon abrasion with another device's data surface. Further the present invention may utilize the same commonly utilized gum label adhesive or others that leave lesser residual residue upon removal as the product does not cover the actual data containing portions of the disc's read surface. The present invention is comprised of two concentric rings that border but do not encroach on the data-containing surface. A removable adhesive with sufficient cohesive strength to retain the protectors through its intended life cycle yet will remove with little or no damage to the product or the disc substrate. These rings utilize the nesting piece within jewel cases to index and apply in a mistake proof manner both rings and with minimized risk of damaging the data surface. Proper indexing is essential to assure that the outer diameter of the disc is not exceeded such that it will not feed into slot feed type automotive CD or DVD players. The present invention, in its preferred embodiment also utilizes high-density paperboard whose outer ring provides more mass at the outer edge of the disc than either Burroughs or Winicki's inventions, thus affording superior rotational inertial properties for skip resistance. As will be presented below, the present invention overcomes the aforementioned disadvantages of the prior art while affording these preceding benefits and other additional unique objects and advantages.

### SUMMARY OF THE INVENTION

The present invention, in its preferred embodiment, is an optical storage device protector comprised of two concentric rings applied to the disc data surface, bordering but not encroaching on the inner concentric data containing region. The present invention affords the following advantages while overcoming the disadvantages of the prior art.
a) An optical data storage protection device that utilizes the universally used jewel case to index both the inner and outer protective rings to the storage device simply and reliably;
b) An optical data storage protection device that provides a physical barrier that prevents direct storage device data surface contact with most contaminants without physically covering the actual digital data, thus allowing the data surface to be cleaned;
c) An optical data storage protection device whose outer ring's, outer peripheral edge serves as a cushion affording additional disc edge protection;
d) An optical data storage protection device that may utilize common removable gum adhesive or others that provides secure adhesion and a clean, residue free removal for easy replacement and whose adhesive deposit, if left, is left in a location being outside the data containing portion of the read surface thereby not obscuring readability;
e) An optical data storage protection device that may be produced of a paper based product that is ideally porous to receive a variety of printed patterns or colors to classify music or movie or video game collections by category;
f) An optical data storage protection device that is ideally porous to receive a variety of printed patterns, colors or logos for providing advertising of other products;
g) An optical data storage protection device that is ideally porous to receive a variety of printed patterns, colors or logos for effectively marketing the product;
h) An optical data storage protection device providing an means for color coding different music types and movie types within a personal collection;
i) An optical data storage protection device whose external surface is coated with either acetates, clear coating, overlaminating, or various other protective coatings making it water, smudge and scuff resistant for longer life and affording colored surface protection;
j) An optical data storage protection device whose face material is softer than the plastic disc material it protects and the hard plastic covers of Burroughs' and Winicki's inventions and will not scratch or scuff in contact with an adjacent disc's data surface;
k) An optical data storage protection device whose basis weight is higher density than that of Burroughs' or Winicki's inventions, providing additional mass to the disc's periphery, causing it to remain more stable within the plain of rotation making it less prone to skipping when applied to CD's played in portable CD or car mounted CD players;
l) An optical data storage protection device providing a means, unique to the art, of identifying ownership of a given CD or DVD collection by custom label printing ability using a personal computer and printer with existing CD label printing software;
m) An optical data storage protection device that can have user defined art applied using the current label application process used for computer generated and printed CD or DVD labels;
n) An optical data storage protection device affording a less expensive product to produce, than that of the closest CDfender or Winicki prior art, whose transparent covers must be made of optical grade polycarbonate and cover the entire data containing surface portion of the data surface of the disc. The present invention may be made of less expensive materials and can utilize the less expensive label manufacturing process, and requires less material to accomplish adequate disc protection;
o) An optical data storage protection device that uses a more flexible variety of these less expensive paper board, velum, latex paper, metalized paper, phosphorescent face material, polyester, hologram paper or other common label materials than, that of the CDfender or Winicki prior art;
p) An optical data storage protection device that is less complex to produce than the CDfender prior art, whose bonding surface requires a “couplant” that prevents obscuring the laser from reading the disc. The present invention may utilize a commonly used, less specialized and expensive, removable gum label adhesive for bonding to the disc;
q) An optical data storage protection device whose laminating production process does not require an expensive 10,000 clean room environment nor expensive universal roll corona treating stations to prepare the product for adhesive application as does the CDfender of the prior art;
r) An optical data storage protection device whose inner ring assembly has an inner edge that affords additional frictional gripping benefits with the spindle certain of disk playing devices.

### DESCRIPTION OF DRAWINGS

FIG. 1 shows a perspective view of the preferred embodiment of the Optical Data Storage Device Protector oriented as would be in application to the data storage side of a disc. Outer ring assembly 1 is shown with its peel away, release liner 1A, high-density face material layer 1B and face coating 1C. Inner ring assembly 3 is also shown with its similarly corresponding peel away release liner 3A, high-density face material layer 3B and face coating 3C.

FIG. 2 shows a topside view of outer ring assembly 1 & inner ring assembly 3, with section 2 and section 3 taken parallel to outer ring assembly 1 and inner ring assembly 3 respectively. The rings are shown in their applied orientation to the data surface of a disc.

FIG. 3 shows the enlarged section 2 taken through outer ring assembly 1, making apparent and clearer the orientation of the aforementioned layers 1A, 1B and 1C. Also shown is inner edge 1D that borders the outer limits of the data-containing portion of the disc read surface and outer edge 1E that provides a cushioning edge protecting benefit to the outer periphery of a disc.

FIG. 4 shows the enlarged section 3 taken through inner ring assembly 3, making apparent and clearer the orientation of the aforementioned layers 3A, 3B & 3C. Also shown is inner edge 3D that provides additional spindle gripping frictional benefits and outer edge 3E that borders the inner boundary of the data-containing portion of the disc read surface.

FIG. 5 shows inner ring assembly 3 with its peel away release liner 3A partially removed for discussion and consideration. Adhesive 4, located under high-density face material layer 3B and release coating 5 that facilitate release liner removal are also presented.

### DETAILED DESCRIPTION OF PREFERRED EMBODIMENT

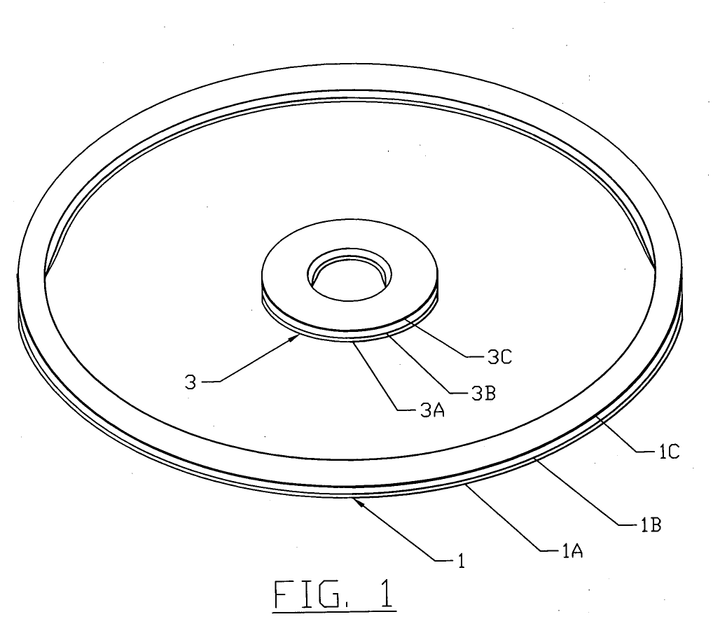

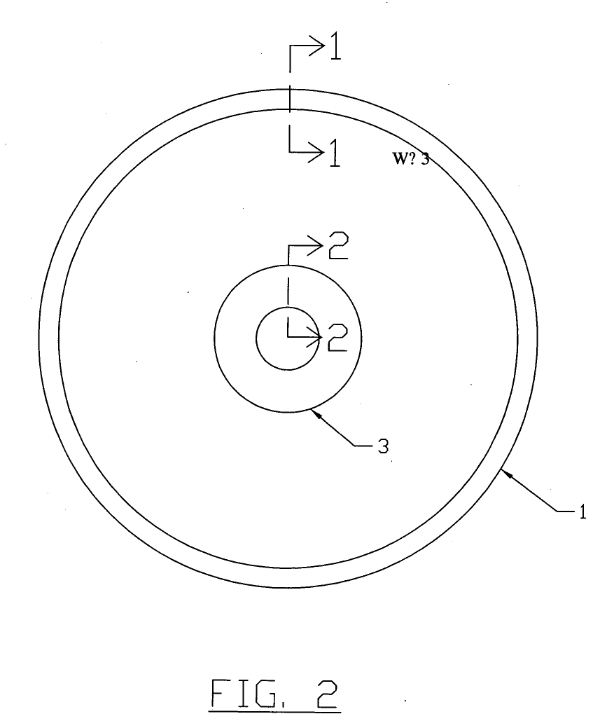

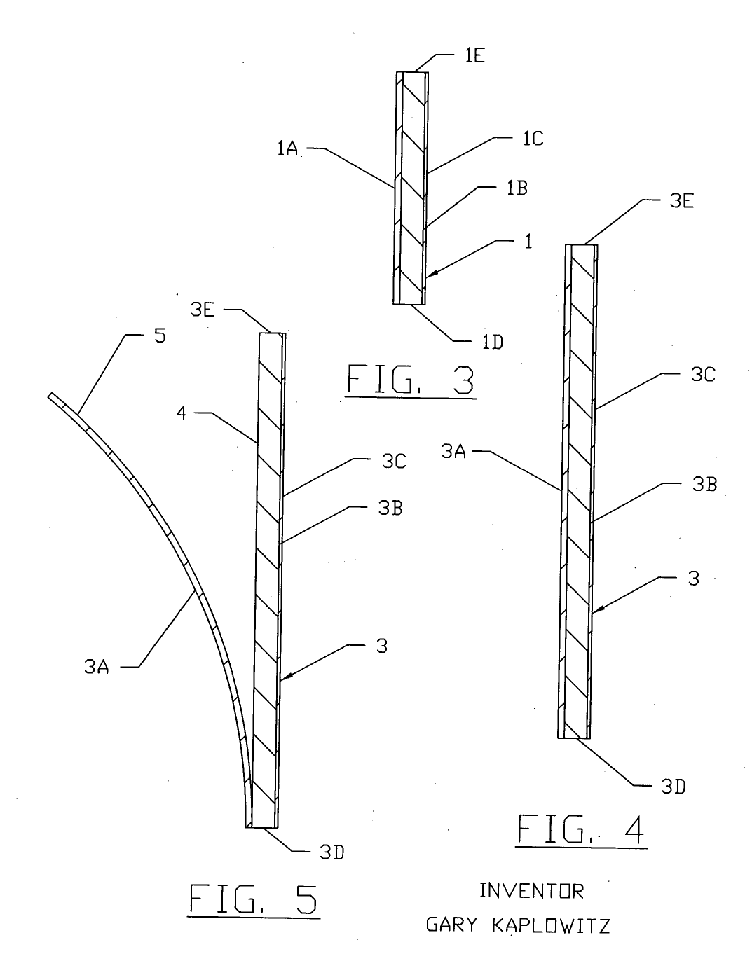

Certain terminology is used herein for convenience only and is not to be taken as a limitation on the present invention. Referring to FIGS. 1, 2, 3, 4 and 5, FIG. 1 shows outer ring assembly 1 and inner ring assembly 3 with respective release liners 1A & 3A, face material layers 1B & 3B and face coatings 1C & 3C. In the preferred embodiment the composition of the release liners is not as critical to the performance of the present invention, but may be comprised of any of many materials customarily used in the art of label production. The composition of face material layers 1B & 3B can vary substantially dependent upon the type of decorative finish that is desired for the purpose of marketing or dependent upon the printing source to be utilized. An ideal common denominator regardless of printing source or decorative finish is that the material is of high-density properties in order to enhance the dynamic stability of the rotating disc while in use. The face material thickness dimension should not exceed 0.040 inch, as this will lift the disk beyond the laser reader focal region limit. The minimum thickness is a matter of standoff height the invention provides above a potentially contaminating surface upon which the read surface may be placed and how much cushioning benefit is desired for the outer disc's periphery by outer edge 3E in FIG. 4 and FIG. 5. The minimum label paper thickness is approximately 0.004 to 0.005 inches thick. It is evident that this would provide little protection to granular types of contaminants such as sand, salt or sugar or others that exceed this thickness in diameter by two or three fold. The maximum thickness of 0.040 most nearly corresponds to high-density card stock or velum material with a basis weight of 60 pounds. However any medium whether paper based or otherwise that can receive a compatible adhesive and serve the desired decorative purposes may be utilized, again with the same high-density properties being a preferred form of face material. In the art of label making and printing, it is recognized that a smudge proof face material that will receive the quick drying ink inherent with laser jet printers is desirable. Therefore, for disc protectors of the present invention intended to be sold for consumer applied printing ability on CD-R's (read only compact discs) or for printing only CD-RW's (read and overwriteable compact discs), this type of material is preferable. In similar manner, other face materials may lend themselves more successfully to various forms of printing methodology or the type of marketing approach desired. For example, the possible application of holograms, pearlescent decoration, phosphorescent or translucent finishes or even debossing wherein an image is depressed below the normal surface of the material may dictate a preferable choice of face materials 1A & 3A. The ideal width of outer ring 1 is approx. 3/16 inch or 0.1875 inches. This also corresponds to the maximum width considered allowable to prevent encroaching on the outer perimeter of the data-containing portion of the read surface. This width takes into account the width of the laser beam reader lens needed to assure that at least the first of the multiple redundant beams and readers can successfully scan this outermost data ring. For the optimal inertial properties of providing greater mass at the perimeter and to allow successful use of removable adhesives, it is also desirable that this ring width be maximized. If this ring is reduced below 1/8 inch or 0.125 inches, with the outer diameter held constant, the lack of bonding surface area makes the use of removable adhesives unworkable provide adequate cohesion to last for the desired life cycle of the product. Both outer ring assembly 1 and inner ring assembly 3 are designed to utilize the nesting surface of common jewel cases to accurately locate both rings to the disc. Outer ring 1 utilizes the relatively close tolerance recess that corresponds closely to the disc's outer perimeter to index itself to the disc. The nesting surface corresponding to the outer periphery slopes down and inwards on most jewel cases and serves to guide the disk to its final nesting position at the base of the nesting piece. The diameter at the bottom in most instance measures approximately 4.76 to 4.80 inches affording approximately 0.010 to 0.020 inches clearance between the disc's outer perimeter edge and the bottom, nesting periphery. As of this writing most CD and DVD discs measure 4.74 inches. This clearance allows the benefit of having the outer diameter of the outer ring assembly 1 exceed the disc outer diameter by at least 0.020″ or measure approximately 4.76 inches affording an improved cushioning benefit. Since disc edge protection is an object of the present invention, it is desirable to have this outer diameter measure at a minimum of the disc's diameter of 4.74 inches. When the outer diameter of outer ring assembly 1 exceeds 4.81 inches, not only does the ring not index properly but also poses a functional problem in some of the slot feed type of disc playing devices made today, such as are found in car CD players. The inner ring 3 has a preferred maximum with of 1 3/8 inches (1.375 inches) as this is just under the approx. 1.380 to 1.385 inch limit of the raised inner ring that borders the data containing portion of the read surface. This raised ring borders the data surface and the clear serial data recording area at the disc's center. In order to assure that the disc remains essentially coplanar during operation, it is not desirable to have any portion of the inner ring overlap this raised border, thus creating a standoff thickness inconsistency, which was shown to affect the readability of the disc in some disc players. The provision of a wider inner ring 3 dimension affords the benefit of greater support of the disc when laid on its data surface side on another flat surface. This greater inner ring-bearing surface makes the disc less prone to warp downward when multiple discs are stacked on top of each and less prone to become contaminated or damaged. Again, maximum inner ring width also affords the additional inertial benefit of providing additional mass. Albeit the increased mass benefit of inner ring 3 is of lesser consequence than that of the outer ring 1 whose greater radial distance from the center of rotation results in much greater inertial benefits. The minimum width of inner ring 3 is the same as for the outer ring 1, of ⅛″ for the same cohesion limitations of using the desired removable adhesive. The center hole of inner ring 3 should be ideally 0.594 to 0.600 to assure proper indexing on the jewel case holder's spindle retainer to accurately locate the ring with the outer dimension and creating the optimal object of creating additional friction between the spindle and the disc. The disc holes for CD's for example are almost invariably 0.593 to 0.595 inches. To make the hole smaller in the range of less than 0.585 creates interference fit with the actual spindle off the disc player and makes disc insertion difficult and ultimately impossible as the diameter reduces. The choice of specific face coatings 1C & 3C (FIG. 1 through FIG. 5) is preferably a clear coat having durable yet a lesser hardness than the polycarbonate or other plastic disc materials currently used in the disc prior art to avoid scuffing the data or label surfaces. However, acetates, overlaminating, lacquers or various other protective coatings affording water, smudge and scuff resistance for longer life and affording colored surface protection may also be used successfully. A pressure sensitive, gum based, removable adhesive is preferable for adhesive 4 (FIG. 5). Particularly one affording satisfactory adhesion to hold the protectors in place for the intended life cycle but also may be removed with little or not damage to the disc substrate material and also does not leave a residue or deposit on the disc's surface. Since the total thickness of the product is critical as mentioned above, so as not to exceed the laser reader focal range, it is apparent that the less residue build-up the better. However, any water-soluble adhesive may also be utilized which will allow complete residue removal during disc cleaning. However, since water resistance is a desirable object of the present invention, and exposure to moisture will partially dissolve the adhesive, this choice of adhesive is less preferable than the aforementioned removable gum based form. The release coating 5 composition, like the release liners 1A & 3A is not a critical component to the performance of the present invention, but may be of the standard silicone based composition common to the label art. The only necessary factor is that release coating 5 is compatible with the specific adhesive 4 utilized to allow easy liner 1A & 3A removal. It is to be understood that the form of the invention herein shown and described is to be taken as a preferred example of the same. Various changes in the shape, size, materials and arrangements of parts may be resorted to without departing from the spirit of the invention or the scope of the appended claims. Many other variations are possible. For example the disc dimensions above would be larger for obviously smaller for proper use with the smaller game discs and MP3 and MP4 discs. Should the efficiency of data storage improve such that discs contain a much smaller bandwidth of actual data containing area within the read surface, the width of the outer ring could become larger without the risk of actual data encroachment. This would afford even more additional mass for dynamic stability during disc usage. Further, as additional high-density materials are developed for label process application, these could be employed with even more dynamic stability benefit than that of the materials presently available within the label production art. Additionally, the dimensions above apply to the standard CD's & DVD's. It is to be understood that MP3 discs, MP4 discs and various game system discs vary substantially from these dimension, and the present invention could also be reduced or increased in size proportionally from any of the dimensional parameters disclosed above for the preferred embodiment without departing from the spirit of the present invention. Further, if the standard jewel case's minimum disc nesting surface were to be enlarged, outer ring assembly 1 could also have a larger outer diameter within the limits of the aforementioned maximum disk diameter limitations of slot feed type of disc playing devices, thus affording additional mass and corresponding improved dynamic stability. The adhesion between the disc and the present invention could also be accomplished utilizing a static charge. The label matrix could be included with the outlines of outer ring assembly 1 and inner ring assembly 3 perforated for easy removal, and distributed in a paper sheet form that readily feeds into laser jet or other printers to include computer applied graphic art.

1. An optical data storage device protector comprised of;
a) A pair of concentric rings, one ring being an outer ring and the other an inner ring;
b) said outer ring and inner ring having a specified inside and outside diameter creating a specified ring width means creating a physical guard, bearing surface or barrier means protecting said optical data storage device's read surface;
c) said outer ring having an inner peripheral edge ending adjacent to but not covering said storage device's data containing portion of said device's read surface;
d) said inner ring having an outer peripheral edge ending adjacent to but not covering said storage. device's data-containing portion of said device's read surface;
e) said inner ring having an inner diameter means indexing to a standard CD jewel case spindle post and storage device playing spindle;
f) said inner and outer rings having a face material layer of a specified thickness means creating a physical standoffs preventing said data storage device from contacting potential contaminants or damaging elements;
g) said outer ring having an outer peripheral edge means protecting said storage device's edge;
h) said inner and outer rings having a label type release liner means covering for a pressure sensitive adhesive;
i) said release liner having a release coating means to facilitate removal of said release liner;
j) said inner and outer rings having a face material surface being receptive to ink or other decorative application;

2. The face material layer of claim 1 receiving a face coating means of protecting ink or decorative surface and enhancing product durability.

3. The optical data storage device protector of claim 2 wherein the outer ring's outer diameter exceeds that of the storage device by a specified amount means of enhancing storage devices edge protection.

4. The optical data storage device protector of claim 1 wherein the face material layer is made of a vegetable or wood pulp based material.

5. The optical data storage device protector of claim 1 wherein the storage device is compact disc (CD).

6. The optical data storage device protector of claim 1 wherein the storage device is digital versatile disk (DVD).

7. The optical data storage device protector of claim 1 wherein the storage device is a music player (MP3) player disc.

8. The optical data storage device protector claim 1 wherein the storage device is a music player (MP4) player disc.

9. The optical data storage device protector of claim 1 wherein the storage device is a game system disc.

10. The optical data storage device protector of claim 2 wherein the face material layer is composed of a high-density paperboard.

11. The optical data-storage device protector of claim 2 wherein the face material layer is composed of Mylar™.

12. The optical data storage device protector of claim 1 wherein the face material layer is composed of a velum.

13. The optical data storage device protector of claim 1 wherein the face material layer is composed of a latex paper.

14. The optical data storage device protector of claim 1 wherein the face material layer is composed of a metalized paper.

15. The face coating of claim 2 comprised of label type clear coating.

16. The face coating of claim 2 comprised of lacquer.

17. The face coating of claim 2 comprised of laminate.

18. The face coating of claim 2 comprised of acetate.

19. The optical data storage device protector of claim 1 wherein the adhesive is a removable type.

20. The optical data storage device protector of claim 1 wherein the adhesive not pressure sensitive by rather made by applying a static charge.
